(19) United States
(12) Patent Application Publication
(10) Pub. No.: US 2014/0279508 A1
(43) Pub. Date: Sep. 18, 2014

(54) SELECTIVE OPERATION OF EXECUTABLE PROCEDURES BASED ON DETECTED GESTURE AND CONTEXT

(71) Applicant: TOLLSHARE, INC., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 13/827,337

(22) Filed: Mar. 14, 2013

(51) Int. Cl. G06Q 20/32; G06F 3/01

(52) U.S. Cl. CPC G06Q 20/3224; G06F 3/017
USPC 705/44; 705/39; 715/863

(57) ABSTRACT

In embodiments, a generic gesture made with a computing device may be detected. In various embodiments, a context of the apparatus and/or a user of the apparatus may be determined. In various embodiments, at least one of a plurality of executable procedures may be selectively operated based on the detected generic gesture and the determined context.

### BACKGROUND

Mobile telephones phones are increasingly being used for functions beyond making telephone calls. For example, so-called “smart phones” are commonly used to access Internet applications (e.g., web services) to enable users to conduct transactions, such as purchasing or selling goods or services, or to participate in social networking. Smart phones equipped with short-range radio technology, such as radio frequency identification (“RFID”), near field communication (“NFC”), WiFI Direct, and/or Bluetooth, are being used increasingly to conduct transactions with other similarly equipped smart phones. However, many smart phones may not be equipped with short range radio technology. For example, the technology may be expensive, or it may be resource-intensive such that it drains a battery. Additionally, smart phones that are only able to communicate using close-range radio technology may not be able to facilitate transactions that require participation from other entities, such as bank and credit card transactions.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example scenario in which a first user causes a first computing device to selectively operate an executable procedure of a plurality of executable procedures based on a detected gesture and a determined context, in accordance with various embodiments.

FIG. 2 illustrates example components of a computing device configured to selectively operate an executable procedure of a plurality of executable procedures based on a detected gesture and a determined context, in accordance with various embodiments.

FIG. 3 illustrates another example scenario in which a user uses a first computing device to selectively facilitate a transaction with a second computing device, in accordance with various embodiments.

FIG. 4 illustrates an example method that may be implemented by a computing device, in accordance with various embodiments.

FIG. 5 illustrates an example method that may be implemented by a back end server, in accordance with various embodiments.

FIG. 6 illustrates an example computing environment suitable for practicing selected aspects of the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, a first computing device 102, configured with applicable portions of the present disclosure and depicted as a smart phone, may be operated by a first user 104. In various embodiments, first computing device 102 may be configured to detect a gesture made by first user 104 using first computing device 102, e.g., using a gyroscope or other motion-related component. In various embodiments, first computing device 102 may match this detected gesture to one of a plurality of generic gestures. First computing device 102 may also detect a context of first computing device and/or first user (example contexts will be described below). Based on the detected generic gesture and the determined context, first computing device 102 may selectively operate one or more of a plurality of executable procedures.

As used herein, an “executable procedure” may include any number of states, transitions between states, actions, or other components that may collectively form a state machine. Non-limiting examples of executable procedure may include selectively conducting transactions with other computing devices, establishing relationships between computing devices and/or users thereof, buying or selling goods or services, and so forth.

For example, in FIG. 1, first computing device 102 is shown defining a virtual perimeter, or “geofence” 106, e.g., as a radius around first computing device 102. A second computing device 108, which may be configured with applicable portions of the present disclosure, is located within geofence 106 and may be operated by a second user 110. When both devices are within geofence 106, a gesture detected at one or both devices may enable either to selectively operate one or more executable procedures of a plurality of executable procedures, e.g., conduct transactions with the other.

In various embodiments, a back end server 120 may be provided to facilitate transactions between computing devices such as first computing device 102 and/or second computing device 108. In various embodiments, back end server 120 may facilitate various aspects of a transaction. For example, in various embodiments, back end server 120 may facilitate authentication of a user identity, e.g., to enable withdrawal of funds from a bank account associated with the user. Back end server 120 may additionally or alternatively facilitate other security aspects of a transaction, such as ensuring that transmitted data is kept private, e.g., using cryptography, inviting devices to join the transaction, and so forth.

While back end server 120 is depicted as a single computing device in FIG. 1, this is not meant to be limiting. In various embodiments, multiple computing devices may collectively and/or independently facilitate various transactions or aspects of transactions between computing devices. Moreover, while back end server 120 is depicted as a physical device, this is not meant to be limiting. Back end server 120 may be any logic implemented using any combination of hardware and software. For example, in some embodiments, back end server 120 may be a process (e.g., a web service, application function, etc.) executing on one or more computing devices of a server farm.

In various embodiments, as part of determining its context, first computing device 102 may be configured to determine that first computing device 102 and/or another computing device is/are suitably located to engage in a transaction. For example, in FIG. 1, first computing device 102 may be configured to determine that second computing device 108 is within a particular proximity of first computing device 102, e.g., within geofence 106. In various embodiments, such a determination may correspond to a scenario in which first user 104 and second user 110 are sufficiently proximate to engage in a social interaction 122. For instance, first user 104 and second user 110 may be close enough to each other to have a conversation, or at the very least may be within each other's line of sight. In various embodiments, first computing device 102 may determine that it is within a particular proximity of another computing device in various ways, including but not limited to use of a global positioning system (“GPS”), close-range radio communication techniques such as radio frequency identification (“RFID”), near field communication (“NFC”), Wifi Direct, Bluetooth, determining that it is connected to the same access point as the remote computing device, and so forth.

In various embodiments, upon determining that first computing device 102 and/or second computing device 108 are suitably located, first computing device 102 may be configured to operate a particular executable procedure of a plurality of executable procedures. For example, first computing device 102 may selectively facilitate a transaction, e.g., through back end server 120, with second computing device 108. The selective facilitation of the transaction may be based on various information collected and/or provided by first computing device 102, second computing device 108 and/or back end server 120. For example, in various embodiments, the transaction may be selectively conducted based on a context of first computing device 102, first user 104, second computing device 108, and/or second user 110. Additionally, the transaction may be selectively conducted based on the detected generic gesture (e.g., a wave) made using first computing device 102 and/or second computing device 108, as well as a connotation that is associated with the detected generic gesture based on the determined context of first computing device 102, first user 108, second computing device 108, and/or second user 110.

In various embodiments, a generic gesture may have multiple connotations (hence the name, “generic”), depending on a context of first computing device 102, and/or first user 104. For example, if first user 104 waves first computing device 102 in a first location, that wave may have a different connotation than if first user 104 waves first computing device 102 in a second location.

In various embodiments, first computing device 102 may include a plurality of executable procedures that it may selectively operate in response to a detected generic gesture and a determined context of first computing device 102 and/or first user 104. For example, one executable procedure may be operated by first computing device 102 if waved by first user 104 in a coffee shop (e.g., first user 104 may be authorizing the coffee shop to deduct funds from the user's bank account in exchange for coffee). Another executable procedure may be operated by first computing device 102 if waved by first user 104 at a rideshare parking lot (e.g., first user 104 may be attempting to form a rideshare relationship with second user 110).

In various embodiments where the executable procedure selectively operated by first computing device 102 is to selectively conduct a transaction with second computing device 108, a first line of network communication 124 (direct or indirect) may be established between first computing device 102 and back end server 120. Likewise, in various embodiments, a second line of network communication 126 (direct or indirect) may be established between second computing device 108 and back end server 120. Using these lines of network communication, first computing device 102 and second computing device 108 may engage in a variety of transactions, including but not limited to exchange of goods or services, alteration of a relationship between first user 104 and second user 110, and so forth.

Relationships between users may be identified in various ways. In various embodiments, relationships may be identified from a “social graph,” such as from friends and/or acquaintances identified in a social network. Users connected via a social graph may be connected to each others' identities, e.g., because they know one another. Additionally or alternatively, relationships between users may be identified from an “interest graph.” An interest graph may be a network of users who share one or more interests or affiliations, but who do not necessarily know each other personally. A non-limiting example of an interest graph may be a rideshare network of users who are willing and/or are capable of participating in ride sharing, e.g., to address traffic congestion and/or save on fuel costs.

FIG. 2 depicts example components that may be found on computing devices configured with applicable portions of the present disclosure, such as first computing device 102. In FIG. 2, first computing device 102 may include selective operation logic 230. Selective operation logic 230 may be any combination of software and/or hardware configured to selectively operate one or more of a plurality of executable procedures 231 based on a context of first computing device 102 and/or first user 104 and a detected generic gesture.

In various embodiments, first computing device 102 may be configured to determine and/or obtain contextual information about first computing device 102 and/or first user 104. In various embodiments, computing device 102 may determine and/or obtain contextual information from “soft” data sources 232 and/or “hard” data sources 234. Selective operation logic 230 may be configured to selectively operate one or more of plurality of executable procedures 231 based on contextual information obtained from soft data sources 232 and/or hard data sources 234 (including a detected gesture).

In various embodiments, soft data sources 232 may include any resource, typically but not necessarily a network resource, that includes contextual information about first user 104. For example, in FIG. 2, soft data resources 232 may include a transaction history 236 of user 104, an online calendar 238 associated with first user 104, a social graph 240 of which first user 104 is a member, an interest graph 242 of which first user 104 is a member, and user preferences 244. From these soft data resources 232, selective operation logic 230 may determine various contextual information about first user 104, such as the user's interests, relationships, demographics, schedule, and so forth.

In various embodiments, hard data sources 234 may include any system resource of computing device 102 that provides contextual information about first computing device 102 and/or data related to a detected gesture. For example, in FIG. 2, hard data resources 234 may include a proximity sensor 246, a barometer 248, an ambient light sensor 250, a Geiger counter 252, an accelerometer 254, a magnetometer 256, a gyroscope 258, a GPS unit 260, and/or a camera 262. These are not meant to be limiting, and various other types of sensors configured to collect various types of data may be included on first computing device 102. One or more of the hard data sources 234, such as gyroscope 258 and/or accelerometer 254, may be used to detect a generic gesture made with computing device 102.

In various embodiments, first computing device 102 may include a library 264 of predefined generic gestures. In various embodiments, first computing device 102 may be configured to match a gesture detected using, e.g., accelerometer 254 and/or gyroscope 258 to a generic gesture of the library of generic gestures 264. Based on this determined gesture and/or an associated connotation, selective operation logic 230 may selectively operate an executable procedure of plurality of executable procedures 231.

Various generic gestures having potentially multiple context-dependent connotations may be included in library 264. For example, in FIG. 2, library 264 may include a wave 266, a shake 268, a pump 270 (e.g., a “fist pump”), and/or one or more custom gestures 272, e.g., created by a particular user. In various embodiments, a user such as first user 104 may custom define his or her own gestures by hitting a “record gesture” button, moving first computing device 102 in a particular manner, and then hitting a “stop recording” button. User may then map those gestures to one or more executable procedures, based on a context of first computing device 102 and/or user 104.

In some embodiments, first user 104 may define a signature gesture that may be used in particular contexts to enable authentication of first user 104 and/or provide an additional security layer. First user 104 may then move computing device 102 in such a predefined manner, e.g., to authenticate the user's identity, much as first user 104 may use a password for authentication.

As noted above, a context of first computing device 102 may include user preferences 244. For example, first user 104 may deliberately configure user preferences 244 of first computing device 102 so that a particular gesture causes a first executable procedure to be operated. Later, first user 104 may reconfigure user preferences 244 of first computing device 102 so that the same gesture will now cause a second executable procedure to occur.

A context may additionally or alternatively include one or more states of first computing device 102. For example, if first computing device 102 is in a first state (e.g., has a map program open) and detects a generic gesture, it may operate a particular executable procedure (e.g., reorient the map, change map viewpoint, etc.). However, if first computing device 102 is in a second state (e.g., map program not open), detection of the same generic gesture may cause a different executable procedure (e.g., unrelated to the map program). Other non-limiting examples of states that may cause first computing device 102 to selectively operate different executable procedures on detection of a generic gesture include, but are not limited to, battery power, temperature (of first computing device 102 or its environment), computing load of first computing device 102, wireless signal strength, channel condition, and so forth.

In some embodiments, first computing device 102 may be configured to track a shape or path in the air created by first user 104 by moving first computing device. For example, first user 104 could, with first computing device 102 in hand, mimic drawing of a particular letter or sequence of letters (e.g., to form a word such as a password) in the air. First computing device 12 may detect this movement, e.g., using accelerometer 254 and/or gyroscope 258, and may match it to a corresponding movement and associated connotation (e.g., a letter).

As an example, suppose first user 104 is a member of a rideshare social network and seeks a ride to a particular location. First user 104 may enter an area defined by a geofence, such as a rideshare parking lot commonly used by members of the rideshare social network, to search for another member going to the same or a similar location, or in the same direction. Second user 110 may also be a member of the rideshare social network. Second user 110 may drive into the rideshare parking lot seeking other members to join second user 110 (e.g., to split fuel costs).

When first user 102 sees second user 110 pull in, first user 102 may move first computing device 102 to form a gesture. Contemporaneously with detecting the gesture, first computing device 102 may determine a context of first computing device 102, second computing device 108, first user 104, and/or second user 110. For example, first computing device 102 may determine that it is located within geofence 106 and/or that second computing device 108 is also located within geofence 106). First computing device 102 may also consult with a soft data source 232, such as social graph 240 or interest graph 242, to confirm that the user associated with second computing device 108, i.e., second user 110, is a member of the rideshare social network. Once the context is determined, first computing device 102 may selectively operate an executable procedure of a plurality of executable procedures that includes authorization and/or authentication of a transaction between first computing device 102 and second computing device 108. For example, first computing device 102 may establish a ridesharing agreement between first user 104 and second user 110.

Selective conduction of a transaction between computing devices may not always be based purely on proximity of the computing devices to each other. In some embodiments, selective conduction of a transaction between computing devices may be based on an absolute location of one or more of the computing devices. For example, in some embodiments, first computing device 102 may be configured to determine its absolute location, e.g., using GPS unit 260. Based on this location, first computing device 102 may be configured to selectively conduct a transaction with another computing device. An example of this is shown in FIG. 3. Many of the components of FIG. 3 are similar to those shown in FIG. 1, and therefore are numbered similarly.

In FIG. 3, first user 104 has carried first computing device 102 into a venue 370. Venue 370 may be any predefined location, including but not limited to a business establishment such as a restaurant, bar or coffee house, an airport terminal, a parking lot, a meeting area, and so forth. In some embodiments, venue 370 may be defined by a geofence (not shown in FIG. 3). In other embodiments, a computing device such as first computing device 102 may determine that it is located in venue 370 based on an access point (e.g., a Wifi access point) associated with and/or contained within venue 370 to which first computing device 102 connects.

In some embodiments, first computing device 102 may be configured to determine a type of venue 370, e.g., based on its location. For example, using GPS coordinates, first computing device 102 may determine that venue 370 is a particular coffee house, or one of a chain of coffee houses. Based at least in part on this determined context, and on a gesture first user 104 makes using first computing device 102, first computing device 102 may selectively operate an executable procedure of a plurality of executable procedures 271.

For instance, in FIG. 3, after first computing device 102 determines that it is located in venue 370, when first computing device 102 detects that it is being moved in a particular manner (e.g., a gesture) by first user 104, first computing device 102 may authorize transactions with computing devices associated with venue 370. A second computing device 308 may be located in venue 370 and may be a computing device with which first computing device 102 may facilitate a transaction, such as a cash register or vending machine. Using lines of communication 324 and 326 to a back end server 320 (which may be located in or near venue 370, or elsewhere), first computing device 102, second computing device 308 and back end server 320 may facilitate a transaction.

For instance, back end server 320 may track “rewards” that customers have accumulated, e.g., via repeated purchase of products. First computing device 102 may determine a context of first user 104, including that first user is a member of the rewards program, and/or that first user 104 has accumulated sufficient rewards to earn a prize (e.g., based on transaction history 236). First computing device 102 may transmit this contextual information to back end server 320. Back end server 320 may instruct second computing device 308 to provide the prize to first user 104, e.g., by dispensing the prize or authorizing its release.

FIG. 4 depicts an example method 400 that may be implemented by a computing device such as first computing device 102. Although the operations are shown in a particular order, this is not meant to be limiting, and various operations may be performed in a different order, as well as added or omitted.

At operation 402, first computing device 102 may detect a gesture made by first user 104 using first computing device 102. For example, first computing device 102 may obtain data from accelerometer 254 and/or gyroscope 258. At operation 404, first computing device 102 may match gesture detected at operation 402 to a generic gesture from library 264.

At operation 406, a context of first computing device 102 and/or first user 104 may be determined. For example, at operation 408, a location of first computing device 102 may be determined, e.g., using GPS 260. As another example, at operation 410, first computing device 102 may determine, e.g., using GPS 260 or other components, whether it is within a geofence. As noted above, such a geofence may be defined by first computing device 102 itself or by another computing device. At operation 412, first computing device 102 may determine whether a remote computing device, such as second computing device 108, is also within the same geofence. Myriad other contextual information may be determined at operation 406. For example, first computing device may determine whether a remote computing device is within a particular proximity (e.g., within Bluetooth or NFC range), connected to a particular wireless access point (e.g., Wifi access point at a particular venue), whether first user 104 is a member of a particular rewards program, whether first user 104 has a social graph 240 relationship with a user associated with another computing device, and so forth.

At operation 414, the gesture detected and matched at operations 402-404 may be associated with a connotation, based at least in part on the context determined at operation 406. For example, if first computing device 102 detects that first user 104 is waving first computing device 102 within a predetermined proximity (e.g., in the same geofence) of second computing device 108, then the connotation may be that first user 104 authorizes a transaction between first computing device 102 and second computing device 108, or that a relationship (e.g., in a social graph 240 and/or interest graph 242) should be formed between first user 104 and a user associated with the other computing device.

At operation 416, first computing device may selectively operate one or more of plurality of executable procedures 231 based on the gesture detected at operation 402 and the context determined at operation 406. For example, at operation 418, first computing device 102 may selectively conduct a transaction with a remote computing device such as second computing device 108. Myriad other executable procedures may be selectively operated at operation 416.

For example, in some embodiments, first computing device 102 may, based on the detected gesture, its location and/or a context of first computing device 102 or first user 104, disclose (e.g., broadcast) its availability to enter into a transactions, e.g., a ridesharing agreement. Suppose first user 104 is a member of a rideshare club and carries first computing device 102 at or near a predefined rideshare meeting place. First computing device 102 may broadcast its context and/or availability to enter into a rideshare agreement. In such embodiments, first user 104 may then initiate or confirm willingness to enter into a transaction with another computing device in the area by making a gesture with first computing device 102, and/or by watching for a gesture made by another user using another computing device.

First computing device 102 may detect a gesture made using another computing device, such as second computing device 108, in various ways. For instance, first computing device 102 may cause camera 262 to capture one or more digital images of the second computing device 108. Using various techniques, such as image processing, at operation 420, first computing device 102 may determine whether a gesture made using second computing device 108, captured in the one or more captured digital images, matches a gesture from library 264. In other embodiments, first computing device 102 may detect a gesture made using second computing device 108 in other ways. For example, first computing device 102 may receive other data indicative of a gesture made using second computing device 108, such as a sequence of movements made using second computing device 108, and may match that data to a gesture in library 264.

A variety of executable procedures aside from the examples already described are possible using disclosed techniques. Moreover, various information determined at various operations may be used to facilitate all or portions of an executable procedure. For example, referring again to FIG. 3, assume first computing device 102 is a payment-enabled mobile phone and second computing device 308 is a vending machine. First user 104 may make various gestures with first computing device 102, e.g., waving it when second computing device 308 displays a product that first user 104 desires. This gesture may be detected, e.g., by first computing device 102, and communicated to back end server 320 and/or second computing device 308. Back end server 320 and/or second computing device 308 may match the gesture, e.g., against its own library of generic gestures. Back end server 320 and/or second computing device 308 may determine a context of first computing device 102, first user 104 and/or second computing device 308, and operate a particular executable procedure (e.g., a sale of the desired product). In some embodiments, back end server 320 may keep track of gestures used by specific users to perform various actions. For instance, back end server 320 may translate a detected gesture received from first computing device 102 as a command from first user 104 to authenticate with first user's bank, and then to withdraw funds to pay for a product. Assuming proper authentication and sufficient funds, back end server 320 may then authorize second computing device 308 to fulfill the order, e.g., by dispensing the product.

In various embodiments, after a transaction between first computing device 102 and second computing device 108 is completed, first computing device 102, second computing device 108 and/or a back end server may establish a context for future transactions between first computing device 102 and second computing device 108. For example, first computing device 102 may store identification and/or authentication information associated with second computing device 108, and vice versa. That way, first computing device 102 may be able to connect more easily to second computing device 108 in the future, e.g., for engagement of transactions of the same or similar type. For example, first computing device 102 and second computing device 108 may be configured for “pairing.” That way, when they are later suitably located (e.g., both within a geofence), they may, e.g., automatically or in response to at least some user intervention, establish lines of communication with each other to facilitate transactions. Method 400 may then end.

FIG. 5 depicts an example method 500 that may be implemented by a back end server (e.g., 120, 320), in accordance with various embodiments. At operation 502, the back end server may receive, e.g., from first computing device 102 at the instruction of first user 104, information to enable first computing device 102 to enter into a transaction with second computing device 108. In various embodiments, the information may include but is not limited to a context of first computing device 102, a location of first computing device 102, a gesture detected by first computing device 102 (e.g., made using first computing device 102 or observed being made with second computing device 108), a type of transaction desired (e.g., form a relationship, buy or sell a good or service, etc.), security information (e.g., credentials of first user 104 useable to withdraw funds from an account or use a credit card), and so forth.

At operation 504, the back end server may selectively operate an executable procedure of a plurality of executable procedures. For example, in various embodiments, the back end server may cross check a generic gesture received from first computing device 102 against a library of predefined generic gestures. Then, based on a context of first computing device 102 and/or second computing device 108, the back end server may determine what type of transaction is desired by first computing device 102, perform authentication of first computing device 102, and so forth.

In various embodiments, at operation 506, the back end server may generate and/or transmit, e.g., to second computing device 108, an indication that first computing device 102 desires to enter a particular transaction (e.g., determined based on the detected gesture and context of first computing device 102/first user 104). During this operation or at another time, the back end server may also send other information necessary to enter the transaction to second computing device 108.

At operation 508, the back end server may receive, e.g., from first computing device 102 and/or second computing device 108, information to enable second computing device 108 to enter into the transaction. For example, second user 110 may move second computing device 108 in a gesture (e.g., which may be detected by second computing device 108 or observed by first computing device 102) to indicate that second user 110 is ready to conduct a transaction with first computing device 102. In some embodiments, second computing device 108 may additionally or alternatively provide a context of second computing device 108, security information (e.g., credentials of second user 110), and so forth.

At operation 510, based on various information received from first computing device 102 and/or information received from second computing device 108, the back end server may selectively facilitate the transaction. For example, if credentials received from either first computing device 102 or second computing device 108 are invalid, or if either computing device indicates that it is unable to enter into the transaction, then the back end server may deny the transaction. But if information received from both parties indicates a readiness to enter the transaction from both sides, then the back end server may facilitate the transaction. In various embodiments, at operation 512, the back end server may establish (e.g., store) a context for future transactions of the same type or different types between first computing device 102 and second computing device 108.

FIG. 6 illustrates, for one embodiment, an example computing device 600 suitable for practicing embodiments of the present disclosure. As illustrated, example computing device 600 may include control logic 608 coupled to at least one of the processor(s) 604, system memory 612 coupled to system control logic 608, non-volatile memory (NVM)/storage 616 coupled to system control logic 608, and one or more communications interface(s) 620 coupled to system control logic 608. In various embodiments, the one or more processors 604 may be a processor core.

System control logic 608 for one embodiment may include any suitable interface controllers to provide for any suitable interface to at least one of the processor(s) 604 and/or to any suitable device or component in communication with system control logic 608.

System control logic 608 for one embodiment may include one or more memory controller(s) to provide an interface to system memory 612. System memory 612 may be used to load and store data and/or instructions, for example, for computing device 600. In one embodiment, system memory 612 may include any suitable volatile memory, such as suitable dynamic random access memory (“DRAM”), for example.

System control logic 608, in one embodiment, may include one or more input/output (“I/O”) controller(s) to provide an interface to NVM/storage 816 and communications interface(s) 620.

NVM/storage 616 may be used to store data and/or instructions, for example. NVM/storage 616 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 616 may include a storage resource physically part of a device on which the computing device 600 is installed or it may be accessible by, but not necessarily a part of, the device. For example, the NVM/storage 616 may be accessed over a network via the communications interface(s) 620.

System memory 612 and NVM/storage 616 may include, in particular, temporal and persistent copies of selective operation logic 230. The selective operation logic 230 may include instructions that when executed by at least one of the processor(s) 604 result in the computing device 600 practicing one or more of the operations described above for method 400 and/or 500. In some embodiments, the selective operation logic 230 may additionally/alternatively be located in the system control logic 608.

Communications interface(s) 620 may provide an interface for computing device 600 to communicate over one or more network(s) and/or with any other suitable device. Communications interface(s) 620 may include any suitable hardware and/or firmware, such as a network adapter, one or more antennas, a wireless interface, and so forth. In various embodiments, communication interface(s) 620 may include an interface for computing device 600 to use NFC, Wifi Direct, optical communications (e.g., barcodes), BlueTooth or other similar technologies to communicate directly (e.g., without an intermediary) with another device.

For one embodiment, at least one of the processor(s) 604 may be packaged together with system control logic 608 and/or selective operation logic 230 (in whole or in part). For one embodiment, at least one of the processor(s) 604 may be packaged together with system control logic 608 and/or selective operation logic 230 (in whole or in part) to form a System in Package (“SiP”). For one embodiment, at least one of the processor(s) 804 may be integrated on the same die with system control logic 608 and/or selective operation logic 230 (in whole or in part). For one embodiment, at least one of the processor(s) 604 may be integrated on the same die with system control logic 608 and/or selective operation logic 230 (in whole or in part) to form a System on Chip (“SoC”).

In various implementations, computing device 600 may be a laptop, a netbook, a notebook, an ultrabook, a smart phone, a computing tablet, a personal digital assistant (“PDA”), an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 600 may be any other electronic device that processes data.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus comprising:
one or more computer processors; and
memory coupled to the one or more computer processors and configured to store a library of one or more generic gestures and a plurality of executable procedures;
wherein the plurality of executable procedures are configured to be selectively operated based on a detected one of the one or more generic gestures and a context of the apparatus and/or a user of the apparatus.

2. The apparatus of claim 1, wherein the operated one of the plurality of executable procedure comprises selective conduction of a transaction with a remote computing device.

3. The apparatus of claim 2, wherein the selective conduction is based on a connotation mapped to the detected generic gesture based on the context.

4. The apparatus of claim 3, wherein the connotation associated with the detected gesture comprises authentication to conduct the transaction.

5. The apparatus of claim 2, wherein the transaction comprises purchase or sale of a good or service.

6. The apparatus of claim 2, wherein the transaction comprises establishment of a ridesharing agreement between the user and a user of the remote computing device.

7. The apparatus of claim 2, wherein the context comprises whether the remote computing device is within a geofence.

8. The apparatus of claim 7, wherein at least one of the executable procedures is configured to define the geofence.

9. The apparatus of claim 7, wherein the context further comprises whether the apparatus is within the geofence.

10. The apparatus of claim 2, wherein the context comprises a proximity of the apparatus to the remote computing device.

11. The apparatus of claim 1, wherein the context comprises one or more of an interest of the user, an online relationship of the user, a transactional history of the user and/or apparatus, or an affiliation of the user or apparatus.

13. The apparatus of claim 1, wherein the context comprises a location of the apparatus.

14. The apparatus of claim 1, wherein the context comprises a preference of the user stored in the memory.

15. A computer-implemented method, comprising:
detecting, by a computing device, a generic gesture made with an apparatus;
determining, by the computing device, a context of the computing device and/or a user of the computing device; and
selectively operating, by the computing device, at least one of a plurality of executable procedures based on the detected generic gesture and the determined context.

16. The computer-implemented method of claim 15, wherein the selectively operating comprises selectively conducting a transaction with a remote computing device.

17. The computer-implemented method of claim 16, further comprising associating, by the computing device, a connotation with the detected generic gesture based on the context, wherein the selective conduction of the transaction is based on the connotation.

18. The computer-implemented method of claim 17, wherein the connotation comprises authentication to conduct the transaction.

19. The computer-implemented method of claim 16, wherein selectively conducting the transaction comprises purchasing or selling a good or service.

20. The computer-implemented method of claim 16, wherein selectively conducting the transaction comprises establishing a ridesharing agreement between the user and another user of the remote computing device.

21. The computer-implemented method of claim 16, wherein determining the context comprises determining whether the remote computing device is within a geofence.

22. The computer-implemented method of claim 21, further comprising defining, by the computing device, the geofence.

23. The computer-implemented method of claim 21, wherein determining the context further comprises determining whether the computing device is within the geofence.

24. The computer-implemented method of claim 16, wherein determining the context comprises determining a proximity of the computing device to the remote computing device.

25. The computer-implemented method of claim 15, wherein determining the context comprises determining one or more of an interest of the user, an online relationship of the user, a transactional history of the user and/or computing device, or an affiliation of the user or computing device.

26. The computer-implemented method of claim 15, wherein determining the context comprises determining a location of the computing device.

27. The computer-implemented method of claim 26, wherein determining the location of the computing device comprises determining the location of the computing device based on a wireless access point to which the computing device connects.

28. The computer-implemented method of claim 15, wherein determining the context comprises determining a preference of the user stored in the memory.

29. The computer-implemented method of claim 16, further comprising establishing, by the computing device, a context for future transactions with the remote computing device.

30. The computer-implemented method of claim 15, wherein determining the context comprises determining a type of venue in which the computing device is located.

31. The computer-implemented method of claim 30, wherein selectively conducting the transaction comprises authorizing and/or authenticating the apparatus to engage in a type of transaction associated with the type of venue.

32. One or more non-transitory computer-readable media comprising instructions stored thereon that are configured to cause a computing device, in response to execution of the instructions, to:
detect a generic gesture made with an apparatus;
determine a context of the computing device and/or a user of the computing device; and
selectively operate at least one of a plurality of executable procedures based on the detected generic gesture and the determined context.

33. The one or more non-transitory computer-readable media of claim 32, further comprising instructions stored thereon that when executed, cause the computing device to selectively conduct a transaction with a remote computing device.
